(19) United States
(12) Patent Application Publication
(10) Pub. No.: US 2004/0000734 A1
(43) Pub. Date: Jan. 1, 2004

(54) Centrifugal casting of graphite for rigid insulation

(75) Inventors: William Kapphan, Bristol, WV (US); Allen E. Hill, Clarksburg, WV (US); Robert Lowther, Lost Creek, WV (US)

Correspondence Address: UCAR Carbon Company Inc., Patent Law Department, 1521 Concord Pike, Suite 301, Brandywine West Building, Wilmington, DE, 19803, US

(73) Assignee: UCAR Carbon Company Inc.

(21) Appl. No.: 10/185,032

(22) Filed: Jun. 28, 2002

(51) Int. Cl. B29C 70/32

(52) U.S. Cl. 264/29.1; 425/425; 264/86; 264/311

(57) ABSTRACT

Cylindrical castings (174), suited to thermal insulation applications at high temperatures, are formed by a centrifugal casting process. A mixture of carbon-containing fibers, such as isotropic pitch fibers, and a suitable aqueous binder, such as a sugar solution, is supplied to a rotating drum (12). The mixture is supplied via a feed pipe (18) concentrically aligned with a screen (66) of the drum. The fibers and binder collect on a filter cloth (102) supported by an inner surface of the screen. Excess binder flows through the filter cloth and passes through adjacent apertures (100) in the screen. When a cylindrical preform of sufficient thickness has built up, the drum is disassembled. The preform is dried, to drive off excess water, and heated to a temperature of about 900° C.-2000° C. to form the casting.

### BACKGROUND OF THE INVENTION

1. Field of the Invention

The invention relates to a method of forming a rigid thermal insulation material. It finds particular application in conjunction with a centrifugal process for removing binder fluids from carbon fibers, and will be described with particular reference thereto.

2. Discussion of the Art

Thermal insulation materials formed from carbon fibers exhibit excellent resistance to heat flow, even at high temperatures. Traditionally, a mixture of carbonized cotton or rayon fibers and a binder, such as furfuryl alcohol or starch, is poured into a form or mold fitted with a filter, known as a bleeder cloth. A vacuum is pulled on the bleeder cloth to remove the excess binder. The fibers build up on the bleeder cloth and when the desired thickness is achieved, the fibers are removed as a mat. In another method, a perforated drum is rotated in a bath of the fiber and binder mixture. A vacuum is applied to an interior of the drum and a mat of fibers slowly builds up on the outside of the drum. The mat is dried, for example by induction heating to a temperature of about 1000-1800° C. The rigid mat thus formed is then machined into desired shapes and sealed or coated, for example with a phenolic resin.

For some applications, the insulation material is machined into cylindrical shapes of selected wall thicknesses and diameters. It has been found, however, that the thermal conductivity of the cylindrical piece machined from a larger board varies, depending on the orientation of the cylindrical piece in relation to the board from which it was machined.

The present invention provides a new and improved method and apparatus for preparing an insulation product, which overcomes the above-referenced problems and others.

### SUMMARY OF THE INVENTION

In accordance with one aspect of the present invention, a method of forming a rigid insulation material is provided. The method includes combining carbon-containing fibers with a binder to form a mixture and centrifuging the mixture in a foraminous drum, the binder passing through apertures in the drum, to form a generally cylindrical preform. The preform is heated to a sufficient temperature to carbonize the preform and form the rigid insulation material.

In accordance with another aspect of the present invention, a cylindrical casting is provided. The casting is formed by a method which includes combining carbon-containing fibers with a binder to form a mixture and centrifuging the mixture in a foraminous drum, the binder passing through apertures in the drum to form a generally cylindrical preform within the drum. The preform is heated to a sufficient temperature to carbonize the preform and form the cylindrical casting.

In accordance with another aspect of the present invention, a centrifugal casting system is provided. The system includes a formaminous drum. An inlet pipe carries a mixture of fibers and binder into the drum. A means is provided for rotating the drum. A filter lines the drum, the fibers building up on the filter to form a generally cylindrical preform as the drum rotates.

In accordance with another aspect of the present invention, a method of forming a generally cylindrical casting suited to use as a thermal insulation material at temperatures of over 1000° C. is provided. The method includes mixing carbon-containing fibers with a liquid binder comprising a carbonizable material and pumping the mixture through a feed pipe having a plurality of perforations, the mixture flowing through the perforations. The method further includes rotating a foraminous drum lined with a filter cloth which is outwardly spaced from the feedpipe. The fibers collect on the filter cloth to form a cylindrical preform. The cylindrical preform is heated to a suitable temperature to carbonize the carbonizable material.

An advantage of at least one embodiment of the present invention is that it enables cylindrical products of selected thickness and internal diameter to be produced.

Another advantage of at least one embodiment of the present invention is that thermal conductivity variations in a cylindrical product are reduced.

Another advantage of at least one embodiment of the present invention is that machining costs and material wastage are reduced.

Still further advantages of the present invention will be readily apparent to those skilled in the art, upon a reading of the following disclosure and a review of the accompanying drawings.

### BRIEF DESCRIPTION OF THE DRAWINGS

FIG. 1 is a perspective view of a centrifugal casting system according to the present invention;

FIG. 2 is an exploded perspective view of the centrifugal casting system of FIG. 1;

FIG. 3 is an enlarged perspective view of the centering rod and lower screen support of FIG. 2;

FIG. 4 is an enlarged plan view of a lower surface of the upper screen support of FIG. 2;

FIG. 5 is an enlarged perspective view of the screen and filter cloth of FIG. 1;

FIG. 6 is an enlarged perspective view of the upper end of the feedstock tube of FIG. 2;

FIG. 7 is an enlarged perspective view of the upper end of the feedstock tube of FIG. 2, viewed from above;

FIG. 8 is an enlarged perspective view of the upper end of the feedstock tube of FIG. 2, viewed from below;

FIG. 9 is a side elevational view of a lower end of the drum and centering rod of FIG. 2;

FIG. 10 is an enlarged perspective view of the motor and bracket of FIG. 1, viewed from above;

FIG. 11 is a top plan view of the motor and bracket of FIG. 1;

FIG. 12 is a side view of the feedstock tube of FIG. 1, flattened to show the entire circumference of the feedstock tube;

FIG. 13 is a schematic view showing exemplary steps of a centrifugal casting process according to the present invention;

FIG. 14 is a perspective view of an alternative embodiment of a centrifugal casting system according to the present invention, with a floor panel shown partially cut away and a motor beneath it;

FIG. 15 is a top plan view through a disk formed by the centrifugal casting process with rectangles illustrating areas where thermal conductivity measurements were made; and

FIG. 16 is a top plan view of a disk cored from a block of material with rectangles illustrating areas where thermal conductivity measurements were made.

### DETAILED DESCRIPTION OF THE PREFERRED EMBODIMENT

A process for forming a rigid thermal insulation product includes mixing carbonized fibers with a liquid binder, such as a sugar solution, and introducing the mixture of fibers and liquid binder to a hollow, rotating perforated drum. The excess binder is removed by centrifugal force. The resulting tubular insulation piece has a more uniform thermal conductivity than that achieved in a conventional gravity or vacuum extraction process.

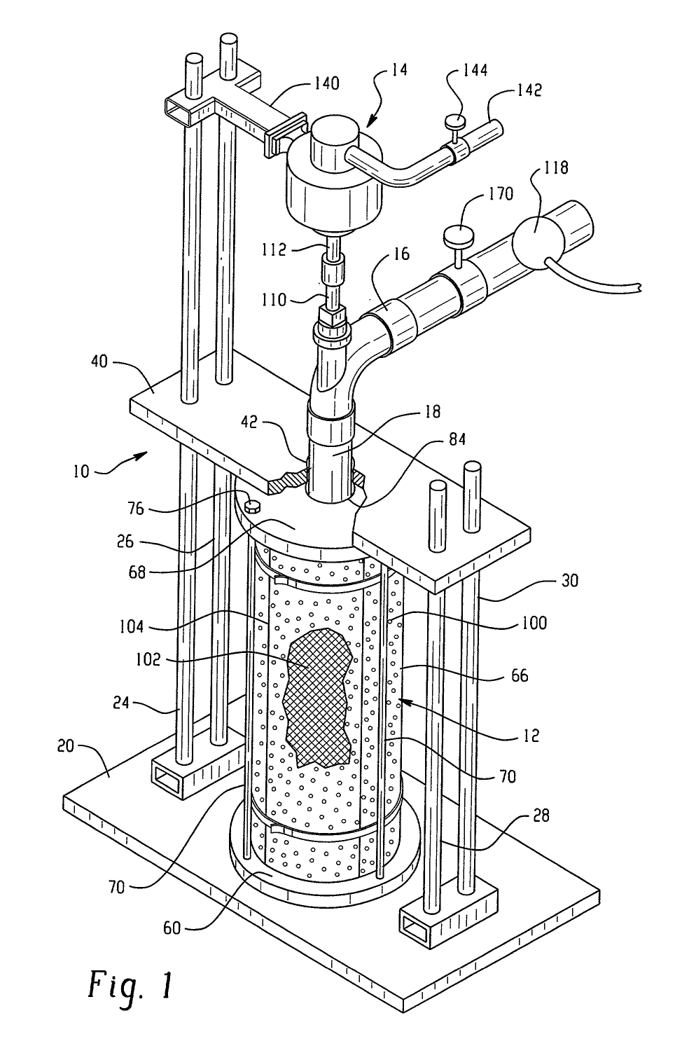

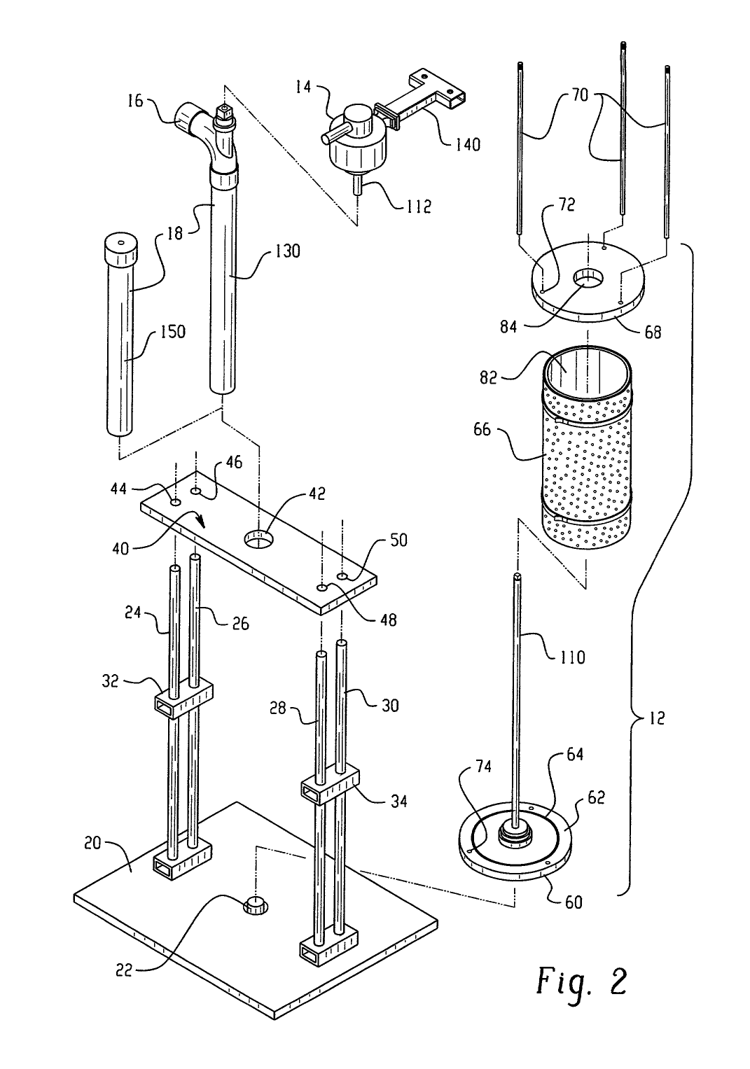

With reference to FIGS. 1 and 2, an apparatus for centrifugal molding of insulating materials is shown. The apparatus includes a support frame 10 and a rotatable drum 12, which is rotated by a motor 14. A feed inlet tube 16 supplies a feed of carbon-containing fibers and a binder as a mixture to a vertically extending feedstock tube or feed pipe 18, which extends into the drum 12.

The support frame 10 includes a base plate 20. A pivot bearing 22 is centrally mounted on the base plate 20 for rotatably supporting the drum 12. Guide rails 24, 26, 28 and 30 are mounted to the base plate 20 in pairs, on either side of the pivot bearing 22. The pairs of guide rails 24, 26 and 28, 30 carry blocks 32, 34, respectively, for supporting a top or stabilizing plate 40, which rests on the blocks. The top plate 40 has a central aperture 42 for receiving the feedstock tube 18 therethrough and four smaller peripheral apertures 44, 46, 48, 50, for receiving upper ends of the guide rails 24, 26, 28 and 30, respectively.

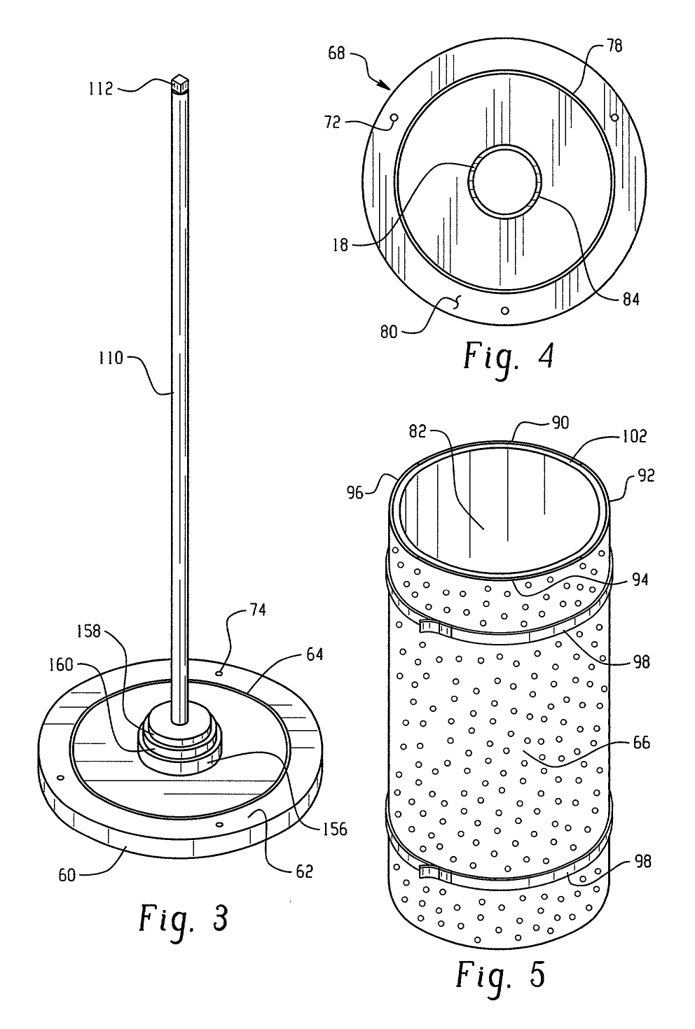

The drum 12 includes a generally circular lower screen support 60, in the form of a plate. The support is rotatably mounted on the pivot bearing 22, for rotation relative to the base plate 20. As shown in greater detail in FIG. 3, an upper surface 62 of the lower screen support 60 defines an annular groove 64, annularly spaced from a periphery of the support 60, which receives a bottom surface of a cylindrical foraminous screen 66 (FIG. 2). The screen 66 is clamped between an upper circular screen support 68 and the lower screen support 60 by radially spaced stay rods 70 (three are shown in FIG. 2). The stay rods 70 are mounted through corresponding holes 72, 74 in the upper and lower screen supports 68, 60,respectively, and are held in place by threaded nuts 76 (FIG. 1). As shown in FIG. 4, the upper screen support 68 is formed with a groove 78 on its lower surface 80, inward of the periphery, for receiving an upper end of the screen 66. The upper and lower screen supports 68, 60 and screen 66 together define an interior chamber 82 (FIG. 5) into which the feed of carbon fibers and binder is fed. A central aperture 84 in the upper screen support 68 receives the feedstock tube 18 therethrough (FIG. 1).

As shown in FIG. 5, the screen 66 may be formed in sections, such as arcuate sectors 90, 92, 94, 96 (four in the illustrated embodiment), which are held together by an annular tension clamp 98 mounted exterior to the screen 66. The screen 66 is perforated with holes, slots, or other apertures 100 (FIG. 1) through which the excess binder flows. The screen 66 is lined with a filter, such as a bleeder cloth 102, which is clamped to the cylindrical screen at edges 104 of the sectors 90, 92, 94, 96 (FIG. 1).

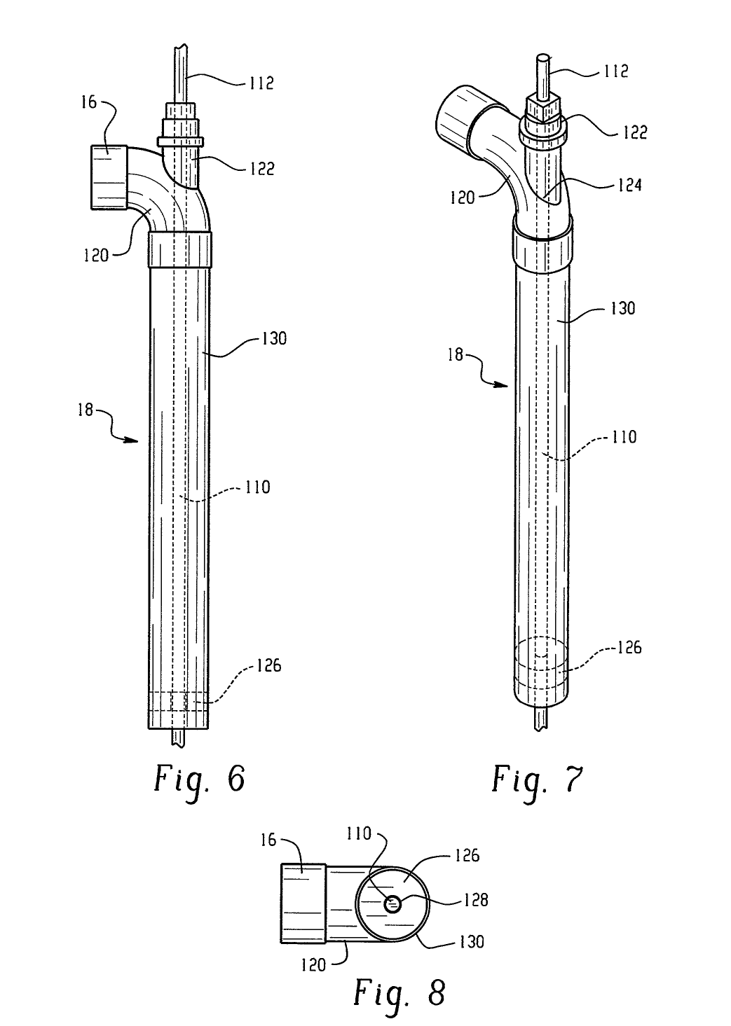

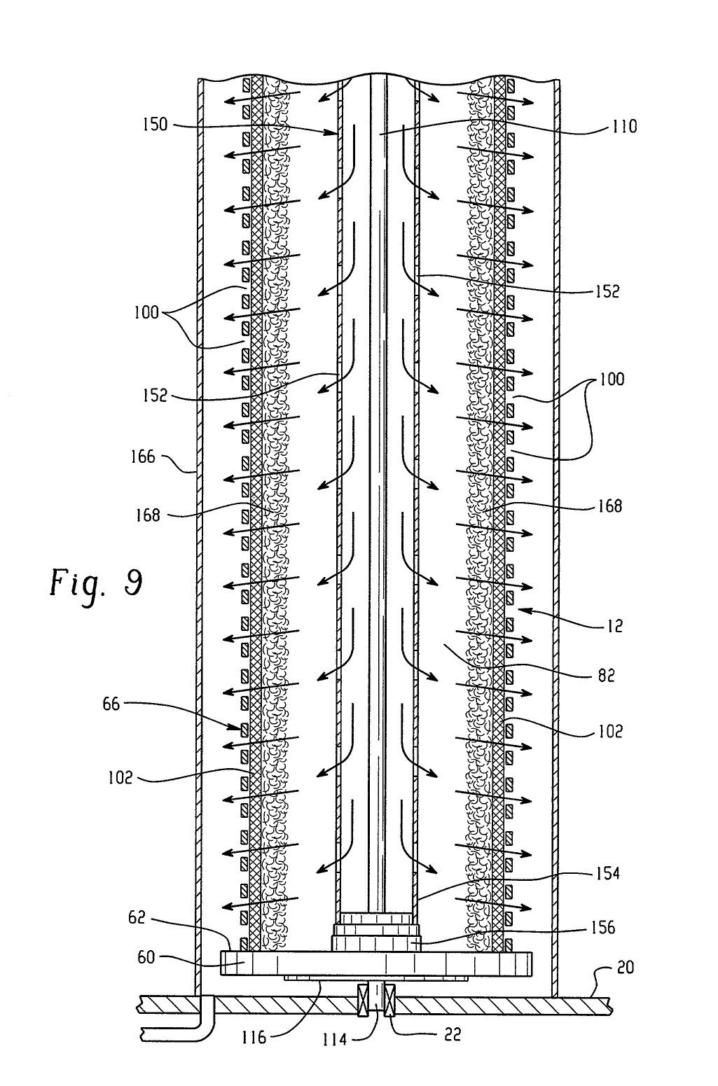

With reference once more to FIGS. 2 and 3, and reference also to FIGS. 6-8, a centering rod 110 is centrally mounted to the upper surface 62 of the lower screen support 60. The centering rod 110 is axially aligned with and passes through the feedstock tube 18 and is connected at an upper end 112 to the motor 14. The motor 14 rotates the centering rod 110, which in turn rotates the drum 12 by rotation of the lower support 60. A bearing rod 114, which extends from a lower surface 116 of the lower support 60 is received within a suitably shaped bore within the pivot bearing 22 and rotates relative thereto (FIG. 9).

Although an air-driven motor 14 and a centering rod 110 are a preferred method for rotating the drum 12, other means for rotating the drum are also contemplated. For example, the pivot bearing 22 may be a rotatable bearing, rotated by a suitable drive system, which may include a motor driven belt, gear system, or other drive member.

A pump 118 (FIG. 1) in the feed inlet tube 16, or fluidly connected therewith, pumps the feedstock through the feed inlet tube. Alternatively, the feedstock is “pumped” by gravity feed from a vessel (not shown) positioned at a sufficient height above the feed inlet tube. As best shown in FIGS. 6 and 7, the generally horizontal feed inlet tube 16 is connected with the vertical feedstock tube 18 by an elbow joint 120. Incoming feedstock in the feed inlet tube 16 thus passes via the elbow joint 120 into the feedstock tube 18. An adapter 122, for supporting the centering rod 110 axially within the feedstock tube 18, is mounted through an opening 124 in the elbow joint 120 and guides the centering rod 110 as it rotates centrally in the vertical feedstock tube 18. A centering disk 126 within the feedstock tube 18 defines a central hole 128 (FIG. 8) for receiving the centering rod 110 snugly therethrough. In the illustrated embodiment, the centering disk 126 is located adjacent a lower end of an upper portion 130 of the feedstock tube 18.

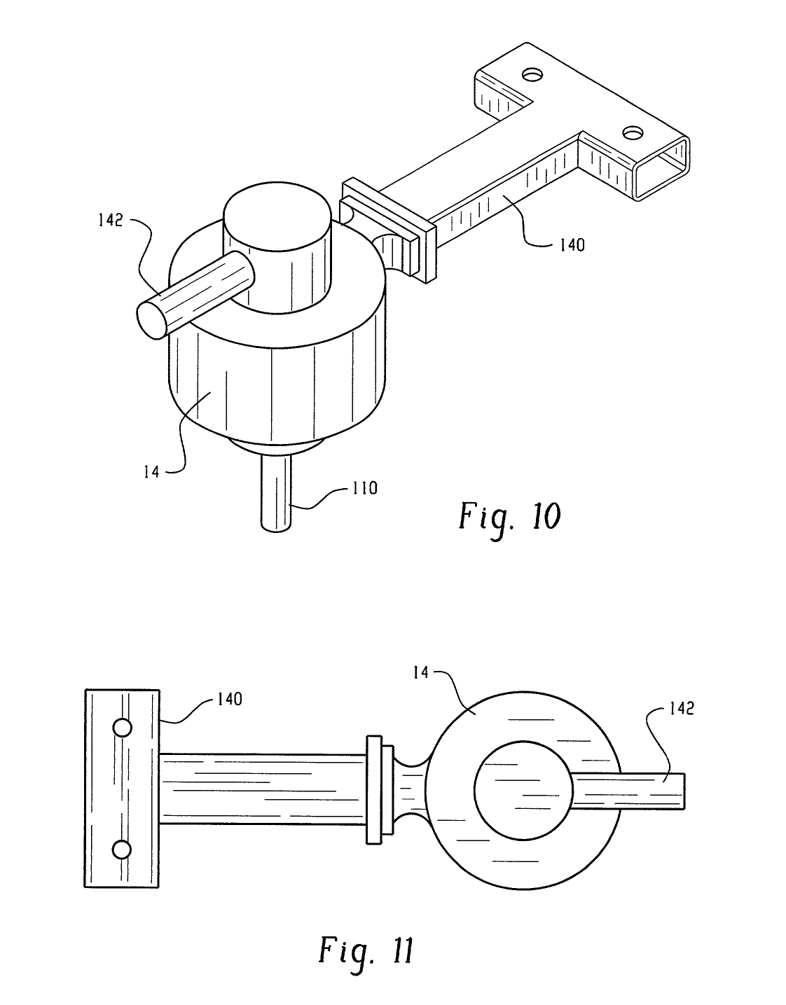

With reference once more to FIG. 1, and reference also to FIGS. 10 and 11, the motor 14 is mounted by a bracket 140 to upper ends of a pair of the guide rails 24, 26. The motor 14 is preferably a gear motor and is advantageously powered by a pressurized gas, such as air, which is supplied to the motor via a gas feed line 142. The speed of the motor, and hence the rotational speed of the drum, is adjustable by varying the flow of the air through the gas feed line 142. A valve or other restrictor 144 in the gas feed line adjusts the air flow to vary the motor speed.

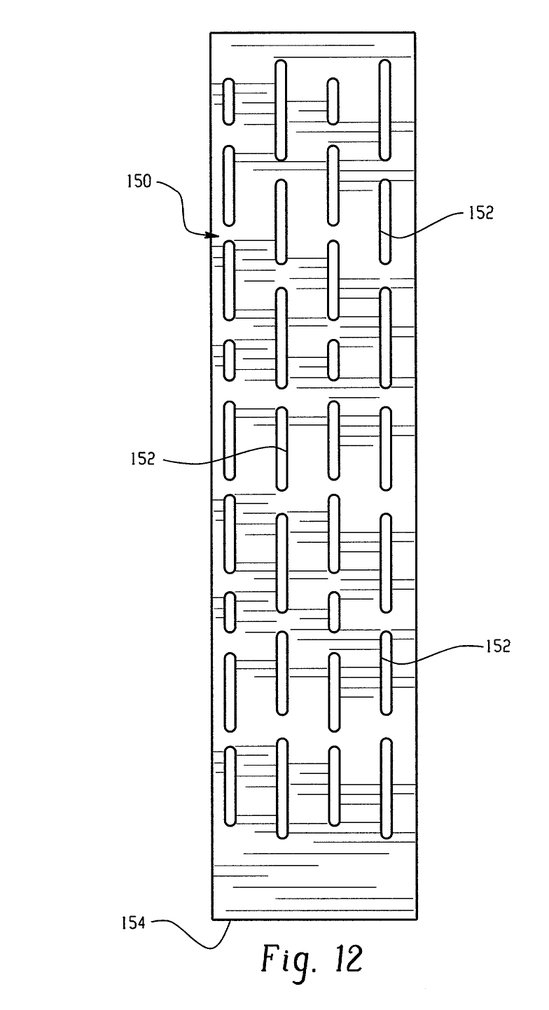

With reference once more to FIG. 2, a lower portion 150 of the feedstock tube 18, which is connected with the upper portion 130, is received within the drum chamber 82. The lower portion 150 is axially aligned with the drum screen 66 and is perforated with slots, holes, or other apertures 152 (FIG. 12), along its length. Having perforations along the entire length, or substantially the entire length, of the lower portion 150 ensures an even buildup of fibers on the bleeder cloth 102. The size and locations of the apertures 152 are selected to achieve an even distribution of fibers on the screen 66.

The lower portion 150 of the feedstock tube is axially mounted within the drum 12 and is radially inward of the screen 66 (FIG. 9). A lower end 154 of the lower portion 150 is closed by a suitably shaped, stepped disk 156, which is centrally mounted to the upper surface 62 of the lower support plate 60. The disk 156 receives the rod 110 therethrough. As best shown in FIG. 3, the disk 156 has steps 158, 160 of different diameters for accommodating different sized feedstock tubes 18. A sealant (not shown) may be applied between the feedstock tube end 154 and the appropriate step 158, 160 to create a fluid-tight seal. Alternatively, a friction fit between the end 154 and the disk 156 creates a liquid-tight or substantially liquid-tight seal.

With reference to FIG. 9, feedstock is introduced to the upper portion 130 of the feedstock tube 18 and flows under gravity and/or under pressure applied by the pump 118 into the lower portion 150 of the feedstock tube. The feedstock passes through the apertures 152 into the drum chamber 82 and is thrown against the bleeder cloth 102. The motor 14 rotates the drum 12 continuously during this process. The centrifugal (or centripetal) force applied to the feedstock forces it against the bleeder cloth 102. The bleeder cloth 102 permits the binder to pass through but retains the carbon fibers on the bleeder cloth 102. The fibers build up as concentric layers on the cloth. Excess binder flows out of the drum screen 66. Optionally, the excess binder is collected in an outer, solid drum 166, from which it is passed to a drain (not shown). A layer 168 of fibers builds up on the bleeder cloth. When a layer of the desired thickness of fibers is achieved (which can be determined from the time over which feedstock is supplied), a valve 170 (FIG. 1) in the feedstock line is closed. After a sufficient period of time to allow excess binder to flow out of the drum 12, valve 144 is closed and rotation of the drum is ceased. The device is then disassembled by unbolting the stay rod nuts 76 removing the upper support plate 68, and unclamping the tension clamp 98.

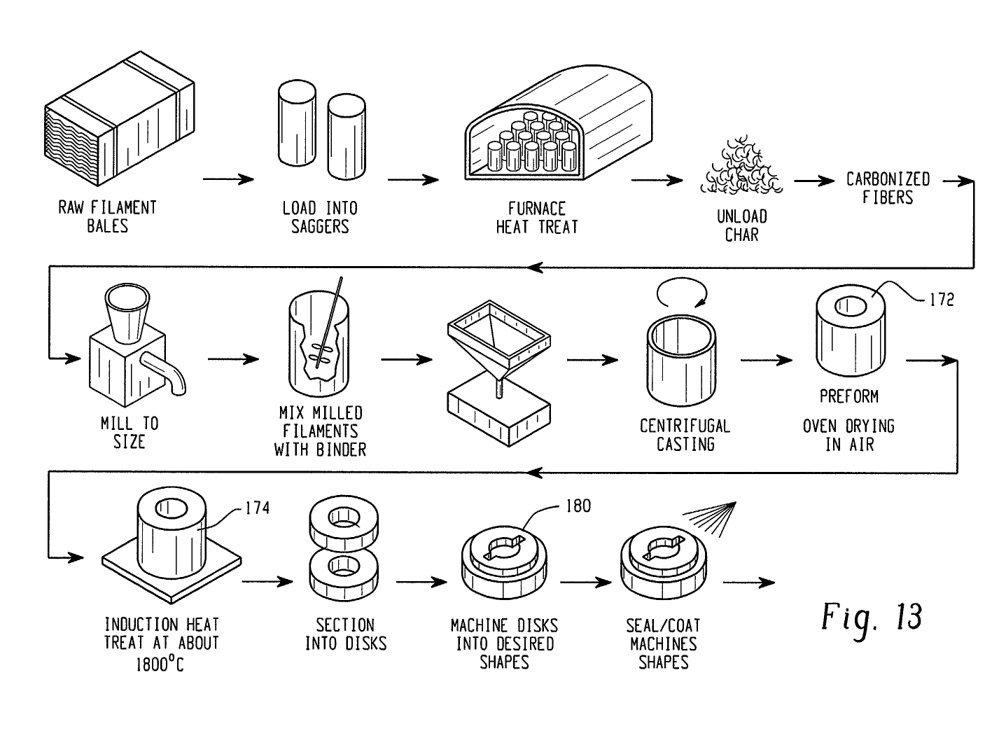

When the sections 90, 92, 94, 96 of the screen are removed, a cylindrical structure or preform 172 (FIG. 13) comprising fibers and a small amount of binder is removed as an integral unit. Three to five minutes of extraction (drum rotation) time is typically sufficient to form the preform. The preform is heated to a temperature of about 200° C. to 300° C. to drive off water from the binder solution. The heat converts the sugar in the binder to an infusible, insoluble form. Specifically, heating carbohydrate leads to chemical removal of OH groups in the form of H₂O and formation of a stable carbon and oxygen-containing polymeric species. The preform is then carbonized to a final temperature of about 900° C. to 2000° C. in an inert atmosphere to remove all (or substantially all) oxygen and produce a carbonized preform or casting 174 (FIG. 13). The carbonization temperature is selected according to the end use of the casting and is generally above the highest temperature to which the casting is to be subjected in use. This reduces the chance for outgassing during use.

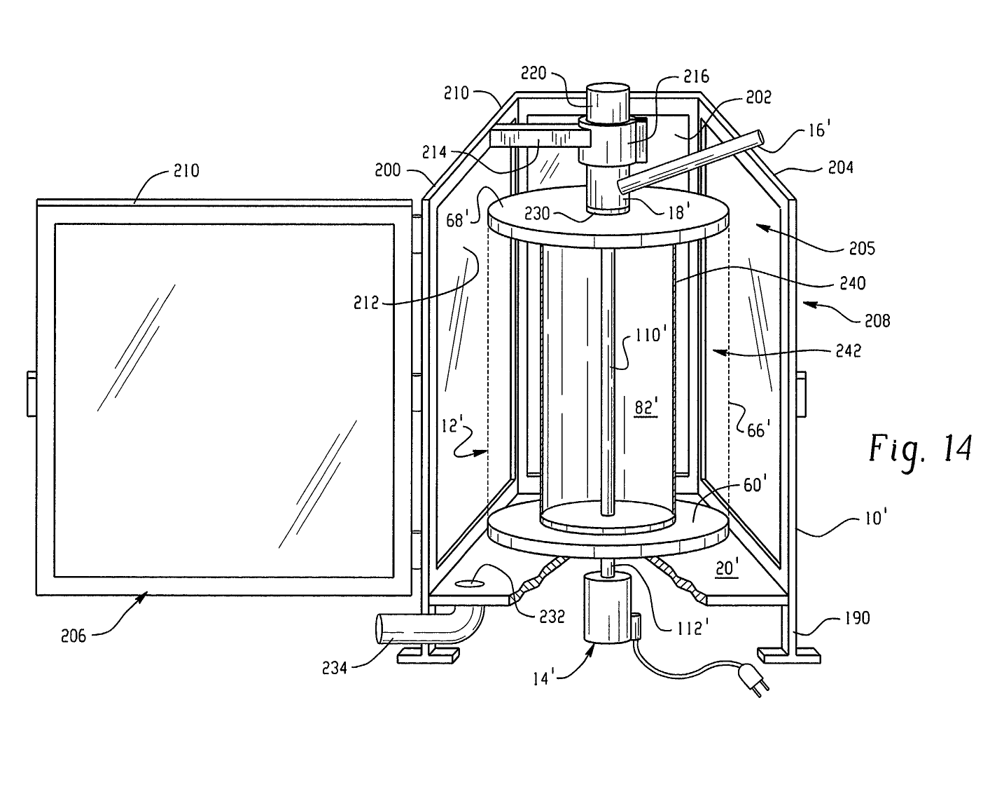

The casting 174 comprises primarily graphite (i.e., at least 95% carbon, more preferably, at least 98% carbon, most preferably, greater than 99.5% carbon) and has a density of typically less than about 1 g/cm³, preferably less than 0.5 g/cm³, more preferably less than 0.2 g/cm³, which is suitable for thermal insulation. The casting can be sectioned into several disks 180 (FIG. 14) of a suitable thickness for a desired application. Final machining, for example, to form slots, grooves or other features in the disks 180 and optionally sealing or coating the disks with a suitable sealant completes the process.

One application for the cylindrical castings 174 is in the forming of fiber optic cables. In this process, molten glass is drawn into a fiber at a temperature of about 1300° C. to 2000° C. A cylindrical casting 174 formed by the present process of about 25-40 cm in height and a cross sectional thickness of about 2-6 cm is used as a drawing tower around the molten fiber optic cable.

The drum screen 66 and lower portion 150 may be about 0.5-2 meters in length and have diameters of about 20-30 cm and about 6-15 cm, respectively, depending on the desired length and diameter of the cast product. As will be appreciated, the screen 66 need not be of a uniform interior diameter, to allow for castings 174 of different dimensions to be formed. Alternatively, the drum may accept tooling to produce multiple outside diameters, inside diameters, and heights of castings 174.

The generally cylindrical, hollow castings 174 produced by this method are suited to use as rigid insulation materials, exhibiting good resistance to heat flow at high temperatures. For example, the castings or disks 180 are suited to use as insulation materials at temperatures of 1500-2000° C., or higher. The hollow disks 180 or other contoured shapes produced have a much more uniform thermal conductivity than those produced by any of the prior gravity or vacuum methods discussed elsewhere herein. Castings having an average thermal conductivity of 0.13 W/m-° K with a standard deviation of less than 0.05 W/m-° K, more preferably, about 0.02 W/m-° K, or less, are readily formed by the above described centrifugal casting method.

With reference to FIG. 14, an alternative embodiment of a centrifugal casting system is shown. Similar elements are given the same numbers, identified by a prime (′), while new elements are given new numbers.

The apparatus includes a rotatable drum 12′, which is rotated by a motor 14′. In this embodiment, the motor is an electric motor and is located below the drum 12′. The drum 12′ is assembled and disassembled in a similar manner to the drum 12. A feed inlet tube 16′ supplies a feed of carbon-containing fibers and a binder as a mixture to a vertically extending feedstock tube or feed pipe 18′. In this embodiment, the tube 18′ is mounted at its lower end to an upper circular screen support 68′ of the drum and does not extend into the drum 12′, although it is also contemplated that a perforated feedstock tube portion analogous to portion 150 may alternatively be employed. A screen 66′ is clamped between the upper circular screen support 68′ and a lower screen support 60′. The upper and lower screen supports 68′, 60′ and screen 66′ together define an interior chamber 82′ into which the feed of carbon fibers and binder is fed. A central aperture (not shown) in the upper screen support 68′ receives the feed mixture from the feedstock tube 18′. The screen 66′ is lined with a filter, such as a bleeder cloth (not shown) analogous to filter 102.

The drum is housed in a frame 10′, which includes a base plate or floor panel 20′, which is mounted above a support surface, such as a floor (not shown) by legs 190 at each of four corners. Vertical sides 200, 202, and 204 extend from the base 20′, and define an opening 205, which is closed, during a centrifuging operation, by a hinged door 206. Together the base plate 20′, sides 200, 202, and 204, and door 206 form a housing 208, which encloses the drum 12′ and catches sprayed binder as it is thrown from the rotating drum. The sides 200, 202, 204, and optionally also the door 206 preferably include an outer support frame 210, formed from metal, or other rigid material, which surrounds and supports a transparent panel or panels 212. This allows an operator to view the rotation of the drum 12′ and detect when the loss of binder is approaching completion.

A stabilizer clamp 214 is mounted to one of the sides 200, 202, 204, or other rigid support surface, and has a hollow, cylindrical releasable clamping member 216, which receives the feed pipe 18′ therethrough. This allows height adjustment of the feedpipe to accommodate screens 66′ of different sizes and for inserting and removing of the screen. In this embodiment, the stay rods 70 are not required.

A centering rod or drive rod 110′ is centrally mounted to a lower screen support 60′ and is axially aligned with and passes through the feedstock tube 18′. Preferably, the centering rod 110′ is connected at a lower end to the motor 14′. The motor 14′ rotates the centering rod 110′, which in turn rotates the drum 12′ by rotation of the lower support 60′. The rotational speed of the motor 14′ is detected by a detector (not shown) and the speed of the motor controlled to achieve a desired rotational speed of the drum 12′. A bearing assembly 220 is supported by the clamp 214 for receiving an upper end of the centering rod 110′.

Feedstock is introduced to the drum 12′ via a manifold 230 at a lower end of the feedstock tube 18′, which includes a plurality of holes (not shown) through which the feed enters the drum. The excess binder which passes through the bleeder cloth and screen enters the housing and is directed to a drain opening 232 connected with a drain line 234.

Optionally, a form 240 in the shape of a cylindrical tube is fitted within the drum 12 to define an inner diameter of the centrifugally cast product. The manifold 230 directs the feed into an annular space 242 between the form 240 and the screen 66′. A number of different diameter interchangeable forms 240 are preferably provided to allow castings 174 of different internal diameters to be formed. Optionally, the form is of varying diameter along its length to provide a casting of non-uniform internal dimensions.

In other respects, the embodiment of FIG. 14 is analogous to that of the embodiment of FIGS. 1-13 and produces a casting 174 with similar properties.

Suitable carbonized fibers for mixing with the binder are formed from cotton, rayon, polyacrilonitrile (PAN), polyacetylene, cellulose, pitch, or other carbonizable materials. The cotton or other fibers are carbonized in a furnace at about 800° C. to form pitch fibers, which are then milled to appropriate size. A particularly preferred carbonized fiber is an isotropic pitch fiber obtained, for example, from Ashland Fibers under the tradename Carboflex™, or from AnShan Chemical Co., China. These fibers are particularly uniform and maintain product properties. They have a density of about 1.6 g/cm³, a diameter of about 12 microns, and are primarily carbon (i.e., greater than 99% carbon). The fibers are preferably milled to an average length of about 100 to 1600 microns.

Suitable binders are carbonizable materials in liquid form, such as carbohydrates, e.g., sugars and starches, or furfuryl alcohol, liquid phenolic resins, and the like. Preferred sugars include sucrose, fructose, dextrose, and maltose. Sucrose is particularly preferred because of its high coking value. A particularly preferred binder includes 15-60% sucrose dissolved in water, more preferably 20-60% sucrose, most preferably about 50-60% sucrose in water. As the sugar content increases, the viscosity increases. At high sugar concentrations e.g., above about 60% sucrose, improved flow may be achieved by heating the fiber and binder mixture, for example, to a temperature of about 60° C.

Optionally, coking additives or other additives may be included in the binder, such as aluminum phosphate or zinc chloride.

Without intending to limit the scope of the invention, the following example demonstrates the improvements in uniformity of thermal conductivity achieved with the centrifugal casting method.

### EXAMPLE

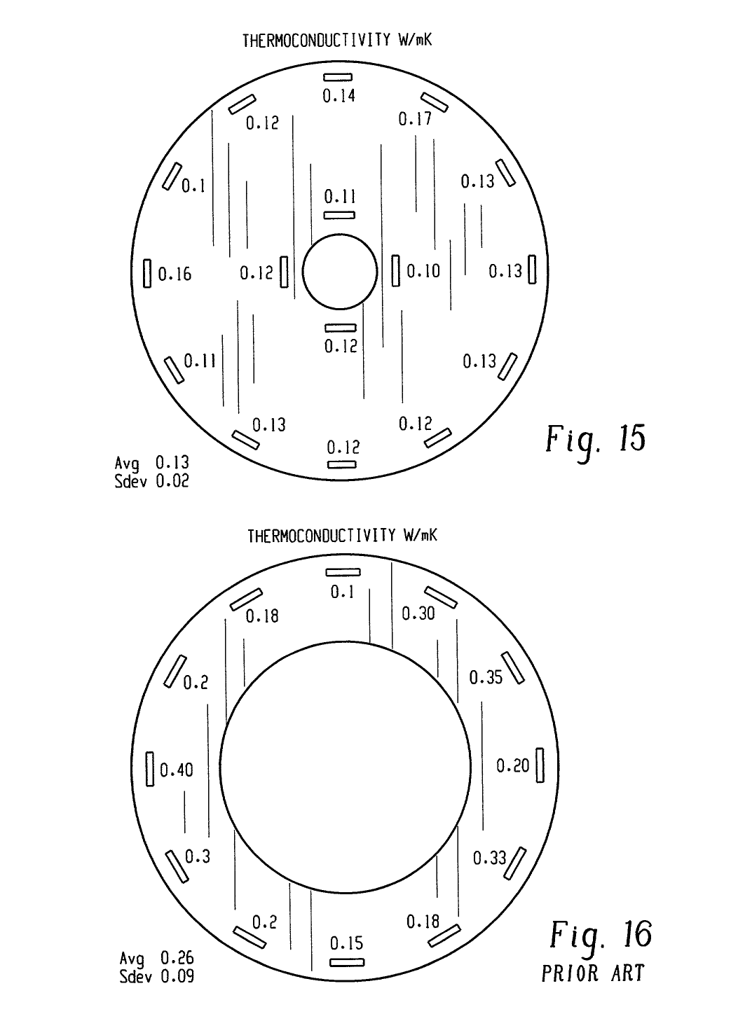

Cylindrical castings 174 were prepared by the centrifugal casting method described above. Isotropic pitch fibers were mixed with a binder comprising about 55% sucrose and cast in the centrifugal casting apparatus into a cylinder. After heat treating to about 1800° C., the cylinder 174 had an outside diameter of 19.05 cm and inside diameter of 3.81 cm. The cylindrical casting 174 was sectioned and conductivity measurements were made in various regions of the disk 180, as shown in FIG. 15. Conductivity measurements were also made on a conventionally-formed disk cored from graphite rigid insulation board stock (FIG. 16). The conventional disk had an outside diameter of 13.61 cm and an inside diameter of 8.58 cm.

As shown in FIG. 16, conductivity measurements on the conventionally-formed cylindrical ring varied from 0.1 to 0.4. W/m-° K, i.e., an average of 0.26 W/m-° K and a standard deviation of 0.09 W/m° K. Expressed as a percentage, the standard deviation was about 35% of the average. In contrast, the thermal conductivity variations in centrifugally cast ring (FIG. 15) were significantly lower. The average thermal conductivity was 0.13 W/m-° K, and the standard deviation 0.02. Expressed as a percentage, the standard deviation was about 15%, substantially less than that for the conventional casting.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A method of forming a rigid insulation material comprising:
combining carbon-containing fibers with a binder to form a mixture;
centrifuging the mixture in a foraminous drum, the binder passing through apertures in the drum to form a generally cylindrical preform; and
heating the preform to a sufficient temperature to carbonize the preform and form the rigid insulation material.

2. The method of claim 1, wherein the carbon-containing fibers are selected from the group consisting of carbonized rayon, cotton, polyacrylonitrile, polyacetylene, cellulose, pitch, and combinations thereof.

3. The method of claim 2, wherein the carbon-containing fibers include isotropic pitch fibers.

4. The method of claim 1, wherein the binder includes a carbonizable material.

5. The method of claim 4, wherein the binder is selected from the group consisting of soluble sugars, furfuryl alcohol, starch, and combinations thereof.

6. The method of claim 5, wherein the binder includes a mixture of a soluble sugar and water.

7. The method of claim 1, wherein the drum is lined with a filter, the fibers collecting on the filter during the step of centrifuging.

8. The method of claim 1, further including:
flowing the mixture of carbon-containing fibers and binder into the drum through a hollow tube, the mixture flowing from the tube into the drum through a plurality of perforations.

9. The method of claim 8, wherein the perforations extend substantially along an entire length of a portion of the tube received within the drum.

10. The method of claim 1, wherein the step of heating includes heating the preform to a temperature of at least 900° C.

11. A cylindrical casting formed by a method comprising:
combining carbon-containing fibers with a binder to form a mixture;
centrifuging the mixture in a foraminous drum, the binder passing through apertures in the drum to form a generally cylindrical preform; and
heating the preform to a sufficient temperature to carbonize the fibers and form the cylindrical casting.

12. The cylindrical casting of claim 11, wherein the casting has an average thermal conductivity of less than 0.2 W/m-° K.

13. A centrifugal casting system comprising:
a formaminous drum;
an inlet pipe which carries a mixture of fibers and binder into the drum;
a means for rotating the drum; and
a filter lining the drum, the fibers building up on the filter to form a generally cylindrical preform as the drum rotates.

14. The system of claim 13, wherein the inlet pipe includes a plurality of apertures, such that the mixture and fibers passes through the apertures into the drum.

15. The system of claim 14, wherein the means for rotating the drum includes a drive motor.

16. The system of claim 15, wherein the motor is connected to the drum by a centering rod which passes through the inlet pipe.

17. The system of claim 13, wherein the drum includes:
a plurality of arcuate sectors which are releasably held together by a clamp;
an upper support plate; and
a lower support plate, the upper and lower support plates being releasably held at opposite ends of the arcuate sectors by radially spaced stays.

18. The system of claim 17, wherein the inlet pipe is carried at a lower end thereof by the lower support plate.

19. A method of forming a generally cylindrical casting suited to use as a thermal insulation material at temperatures of over 1000° C. comprising:
mixing carbon-containing fibers with a liquid binder comprising a carbonizable material;
pumping the mixture through a feed pipe into a foraminous drum lined with a filter;
rotating the foraminous drum, the fibers collecting on the filter to form a cylindrical preform; and
heating the cylindrical preform to a suitable temperature to carbonize the carbonizable material.
